(19) United States
(12) Patent Application Publication
(10) Pub. No.: US 2019/0087441 A1
(43) Pub. Date: Mar. 21, 2019

(54) DATA ACCESS METHOD OF TRANSACTIONAL FILE SYSTEM AND ELECTRONIC APPARATUS

(71) Applicant: PEGATRON CORPORATION, Taipei City (TW)

(72) Inventors: Chen-Hsiang Sun, Taipei City (TW); Jui-Ho Chen, Taipei City (TW)

(73) Assignee: PEGATRON CORPORATION, TAIPEI CITY (TW)

(21) Appl. No.: 16/105,824

(22) Filed: Aug. 20, 2018

(30) Foreign Application Priority Data
Sep. 21, 2017 (TW) 106132398

(51) Int. Cl. G06F 17/30

(52) U.S. Cl. CPC G06F 17/30227; G06F 17/30377

(57) ABSTRACT

A data access method of transactional file system and electronic apparatus are provided. The method includes: when performing a data access operation, selecting a valid transaction point as a first transaction point from a transaction point table including a plurality of transaction points; copying the information in the first transaction point to a second transaction point in the plurality of transaction points, and executing the data access operation according to the information in the second transaction point; and when the data access operation is completed, executing a commit instruction and setting the second transaction point as the valid transaction point according to the commit instruction.

### CROSS-REFERENCE TO RELATED APPLICATION

This application claims the priority benefit of Taiwan application serial no. 106132398, filed on Sep. 21, 2017. The entirety of the above-mentioned patent application is hereby incorporated by reference herein and made a part of this specification.

### BACKGROUND

### 1. Technology Field

The present disclosure relates to a data access method and an electronic apparatus applying the method, in particular, to a data access method of transactional file system and an electronic apparatus applying the method.

### 2. Description of Related Art

A file system of a file allocation table (FAT) may be used on a consumption type mobile device, and a file may be operated by using an application programming interface (API) of a standard file system of Microsoft. Therefore, the file system of the FAT realizes an effect that a storage unit of a mobile device uses the same file system with a desktop computer. However, on the mobile device, power-off protection of the file system of the FAT is not perfect. Because the mobile device is an apparatus with low electric quantity and is in an environment with power-off crisis for a long time, when power failure occurs, the file system of the FAT is damaged, causing the state that all file data cannot be accessed.

### SUMMARY

Therefore, the present disclosure provides a data access method of transactional file system and an electronic apparatus applying the method, and provides a capacity of fail-safe of a file system of an FAT on a mobile device.

The present disclosure provides a data access method of transactional file system, which is applied to an electronic apparatus with a storage unit. The storage unit stores a transaction point table, wherein the transaction point table has a plurality of transaction points. The method includes the following steps: selecting a valid transaction point as a first transaction point from the transaction points of the transaction point table; copying information in the first transaction point to a second transaction point in the transaction points, and executing a data access operation according to the information in the second transaction point; and executing a commit instruction when the data access operation is completed, and setting the second transaction point as a valid transaction point according to the commit instruction.

In one embodiment of the present disclosure, when failure occurs in the process of executing the data access operation, the storage unit is restored to a state in which the data access operation is not executed by using the information in the first transaction point.

In one embodiment of the present disclosure, wherein the step of executing the data access operation includes: copying first data corresponding to the first transaction point to generate second data, and storing the second data to a first cluster of the storage unit; using a first flag to mark a second cluster configured to store the first data and a file path of the first data in the storage unit; and executing data access operation on the second data.

In one embodiment of the present disclosure, wherein after the step of setting the second transaction point as a valid transaction point according to the commit instruction, the method further includes: using a second flag to mark a second cluster configured to store the first data and the file path of the first data so as to release a space of the second cluster.

In one embodiment of the present disclosure, wherein the step of copying information in the first transaction point to a second transaction point in the transaction points includes: generating a count value and recording the count value into the second transaction point, and the count value in the second transaction point is greater than count values of other transaction points in the transaction point table.

In one embodiment of the present disclosure, wherein the step of setting the second transaction point as a valid transaction point according to the commit instruction includes: generating check information according to the information in the second transaction point and the count value in the second transaction point, and recording the check information to the second transaction point.

In one embodiment of the present disclosure, wherein the second transaction point in the transaction point table is a next transaction point of the first transaction point.

In one embodiment of the present disclosure, wherein each of the transaction points includes a transaction file allocation table and a file information table.

In one embodiment of the present disclosure, wherein the count value of the valid transaction point is greater than count values of other transaction points in the transaction point table, and the valid transaction point includes correct check information.

The disclosure provides an electronic apparatus. The electronic apparatus includes a storage unit and a processing unit. The storage unit stores a transaction point table, wherein the transaction point table includes a plurality of transaction points. When the processing unit executes data access operation, the processing unit selects a valid transaction point as a first transaction point from the abovementioned transaction points. The processing unit copies information in the first transaction point to a second transaction point in the abovementioned transaction points, and executes the data access operation according to the information in the second transaction point. When the data access operation is completed, the processing unit executes a commit instruction, and sets the second transaction point as a valid transaction point according to the commit instruction.

In one embodiment of the present disclosure, when failure occurs in the process of executing the data access operation, the processing unit restores the storage unit to a state in which the data access operation is not executed by using the information in the first transaction point.

In one embodiment of the present disclosure, wherein in the process of executing the data access operation, the processing unit copies first data corresponding to the first transaction point to generate second data, and stores the second data to a first cluster of the storage unit. The processing unit uses a first flag to mark a second cluster configured to store the first data and the file path of the first data in the storage unit. Then the processing unit executes the data access operation on the second data.

In one embodiment of the present disclosure, wherein after the operation of setting the second transaction point as a valid transaction point according to the commit instruction, the processing unit uses a second flag to mark a second cluster configured to store the first data and the file path of the first data so as to release a space of the second cluster.

In one embodiment of the present disclosure, wherein in the operation of copying the information in the first transaction point to a second transaction point in the transaction points, the processing unit generates a count value and records the count value into the second transaction point, and the count value in the second transaction point is greater than the count values of other transaction points in the transaction point table.

In one embodiment of the present disclosure, wherein in the operation of setting the second transaction point as a valid transaction point according to the commit instruction, the processing unit generates check information according to the information in the second transaction point and the count value in the second transaction point, and records the check information to the second transaction point.

In one embodiment of the present disclosure, the second transaction point in the transaction point table is a next transaction point of the first transaction point.

In one embodiment of the present disclosure, each of the transaction points includes a transaction file allocation table and a file information table.

In one embodiment of the present disclosure, wherein a count value of a valid transaction point is greater than count values of other transaction points in the transaction point table, and the valid transaction point includes correct check information.

Based on the above, the disclosure provides the data access method of transactional file system and the electronic apparatus applying the method, and when a user accesses data, a file system enters a start transaction state. When all access actions in transaction have been successfully executed, commit of establishment of a new valid transaction point will be started. When establishment of the new valid transaction point is completed, the system will enter a committed state, and at the moment, next transaction may be performed. When unpredictable conditions such as power failure and crash occur at the system, the file system may return to a correct state of transaction or a correct state before the data access operation again. Therefore, the disclosure provides the capacity of fail-safe of the file system of an FAT on a mobile device.

In order to make the aforementioned and other objectives and advantages of the present disclosure comprehensible, embodiments accompanied with figures are described in detail below.

### BRIEF DESCRIPTION OF THE DRAWINGS

FIG. 1 is a schematic diagram of an electronic apparatus shown according to an embodiment of the present invention.

FIG. 2 is a schematic diagram of a transaction point table and a data cluster in a storage unit shown according to an embodiment of the present invention.

FIG. 3 is a schematic diagram of a transaction file allocation table and a file information table shown according to an embodiment of the present invention.

FIG. 4A-FIG. 4D are schematic diagrams of executing data access operation shown according to an embodiment of the present invention.

FIG. 5 is a flow diagram of a data access method of transactional file system shown according to an embodiment of the present invention.

### DESCRIPTION OF THE EMBODIMENTS

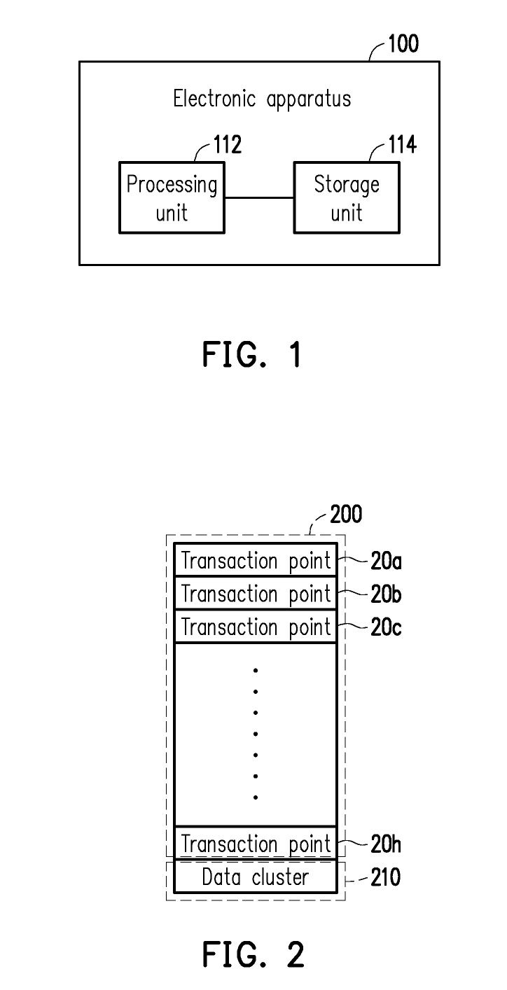

FIG. 1 is a schematic diagram of an electronic apparatus shown according to an embodiment of the present invention. Referring to FIG. 1, an electronic apparatus 100 may include a processing unit 112 and a storage unit 114. The storage unit 114 is coupled to the processing unit 112. In the present embodiment, the electronic apparatus 100, for example, is an Internet of Things apparatus or an embedded system.

The processing unit 112 may be a central processing unit (CPU), or other programmable microprocessors for a general purpose or special purpose, a digital signal processor (DSP), a programmable controller, an application specific integrated circuit (ASIC) or other similar elements or combination of the elements.

The storage unit 114 may be a stationary or mobile random access memory (RAM) of any type, a read-only memory (ROM), a flash memory or similar elements or combination of the elements. In the present exemplary embodiment, the storage unit 114 of the electronic apparatus 100 may store a plurality of program code segments, and after being installed, the program code segments may be executed by the processing unit 112. For example, the storage unit of the electronic apparatus 100 includes a plurality of modules, and these modules respectively execute various operations of the electronic apparatus 100, wherein each module is formed by one or a plurality of program code segments. However, the present invention is not limited to above description, and various operations of the electronic apparatus 100 may also be implemented by other hardware forms.

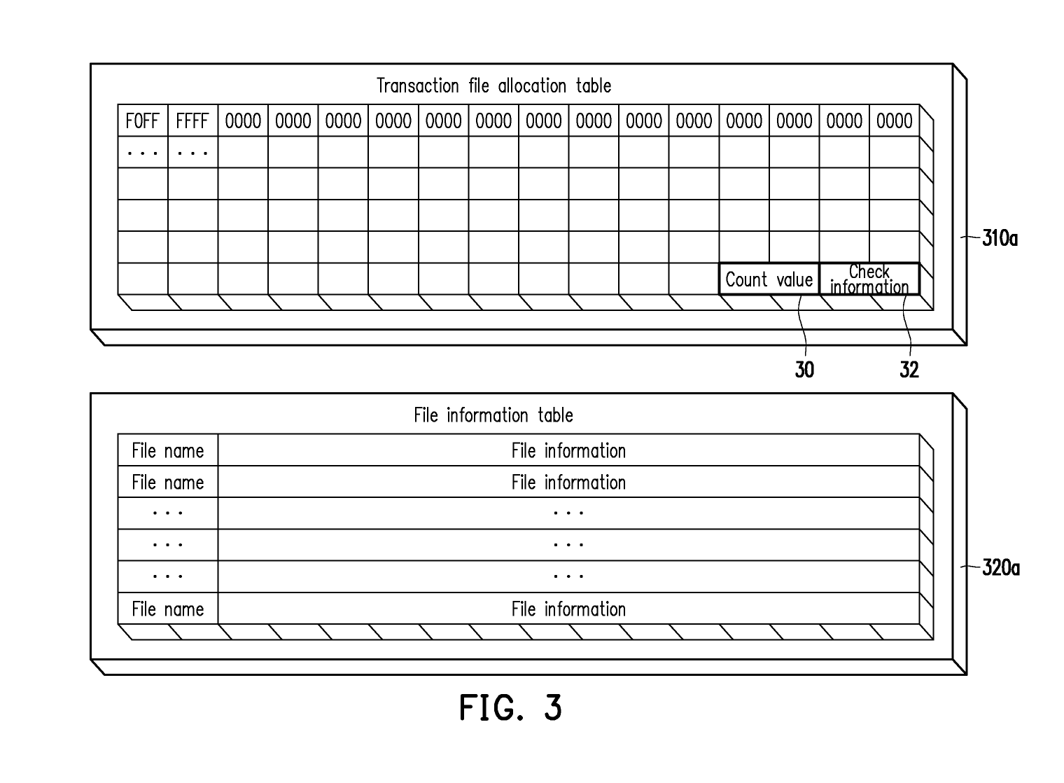

Particularly, in an exemplary embodiment of the present invention, the storage unit 114 further includes a transaction point table and a data cluster. Specifically, FIG. 2 is a schematic diagram of a transaction point table and a data cluster in a storage unit shown according to an embodiment of the present invention.

Referring to FIG. 2, the storage unit 114 includes a transaction point table 200 and a data cluster 210. The transaction point table 200 includes a plurality of transaction points 20a-20h. In the present exemplary embodiment, the transaction point table 200 includes eight transaction points. However, the quantity of the transaction points in the transaction point table 200 is not limited in the present invention. Particularly, in the present exemplary embodiment, because the storage unit 114 is implemented by a non-volatile memory (for example, a flash memory), based on the characteristic that wear may be caused by frequent read or write-in of the same data block (or cluster) in the flash memory, the writing-in or reading frequency of the data block (or cluster) of each transaction point is reduced by using eight transaction points 20a-20h in the present exemplary embodiment, so as to prolong the life of the storage unit 114.

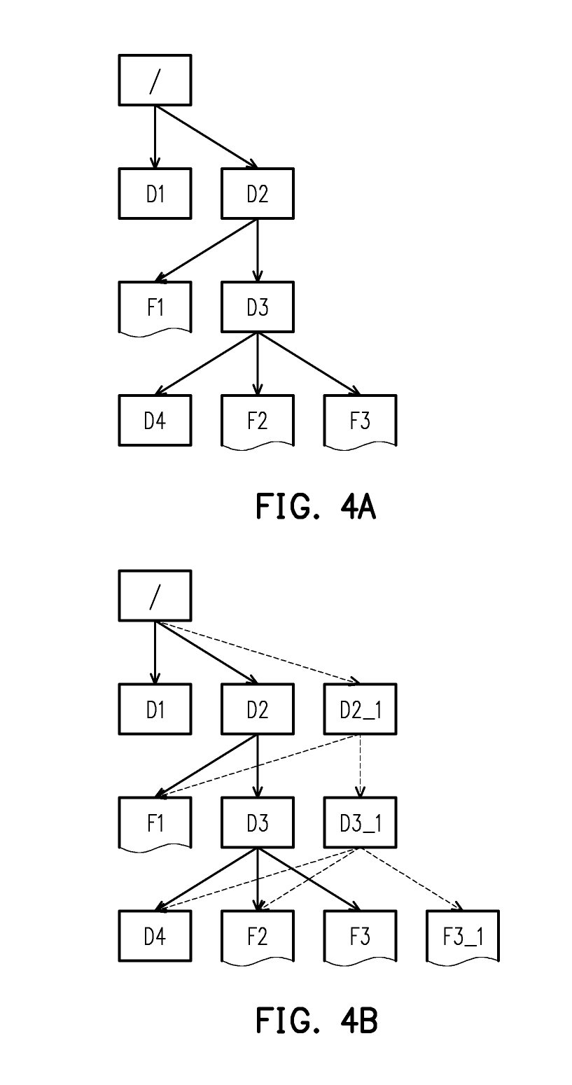

In addition, each transaction point in the transaction point table 200 may include a transaction file allocation table and a file information table. Particularly, FIG. 3 is a schematic diagram of a transaction file allocation table and a file information table shown according to an embodiment of the present invention.

Referring to FIG. 3, because each transaction point in the transaction point table 200 may include a transaction file allocation table and a file information table, the transaction point 20a is taken as an example for illustration herein. The transaction point 20a may include a transaction file allocation table 310a and a file information table 320a. The transaction file allocation table 310a may record a flag of each data cluster in the data clusters 210 of the storage unit or a linkage state of data stored in the cluster. In addition, the transaction file allocation table 310a may also record a count value 30 and check information 32. Particularly, assuming that the count value 30 of the transaction point 20a is greater than count values of other transaction points in the transaction point table 200 and the check information of the transaction point 20a is correct, the transaction point 20a is a newest valid transaction point in the transaction point table 200. In other words, when the transaction point has the maximal count value and the check information of the transaction point with the maximal count value is correct, the transaction point with the maximal count value is the newest valid transaction point.

In addition, in the transaction point table 200, a next transaction point of the newest valid transaction point is the oldest transaction point (that is, the transaction point with the minimum count value). In other words, transaction points in the transaction point table 200 are logically arranged in an annular sequence. For example, assuming that the count value 30 of the transaction point 20a is greater than count values of other transaction points in the transaction point table 200, the sequence from the transaction point with the minimum count value (that is, the oldest transaction point) to the transaction point with the maximal count value (that is, the newest transaction point) is transaction point 20b, transaction point 20c, transaction point 20d, transaction point 20e, transaction point 20f, transaction point 20g, transaction point 20h and transaction point 20a.

The file information table 320a is mainly used for storing file information stored in the data cluster 210. The file information, for example, includes a file name and file information. The file information, for example, may include a file start location of a file stored in the data cluster 210, file size and modification time, etc. The processing unit 112 may find a complete file needing to be accessed by using the file start location in the file information table 320a, a flag of each data cluster in the transaction file allocation table 310a or a linkage state of data stored in the clusters.

Referring to FIG. 2 again, the data cluster 210 is a region actually configured to store a file in the storage unit 114.

In the present exemplary embodiment, when the processing unit 112 needs to execute a data access operation, firstly, the electronic apparatus 100 may enter a transaction start state. At the moment, the processing unit 112 may select a valid transaction point as a first transaction point from transaction points 20a-20h. In the present exemplary embodiment, a count value of a valid transaction point is greater than count values of other transaction points in the transaction point table, and the valid transaction point includes correct check information. That is, the first transaction point is a newest valid transaction point. Assuming that the processing unit 112 selects the transaction point 20a as the first transaction point, then the count value of the transaction point 20a may be greater than count values of other transaction points in the transaction point table 200 and the transaction point 20a includes comet check information.

After the transaction point 20a is selected as the abovementioned first transaction point, the processing unit 112 may copy information (that is, the transaction file allocation table and the file information table of the transaction point 20a) in the transaction point 20a to the next transaction point 20b (also called as the second transaction point), and the processing unit 112 adds one to the original count value of the transaction point 20a to generate a new count value, and records the new count value to the transaction file allocation table of the transaction table 20b. That is, the new count value recorded in the transaction table 20b may be greater than count values of other transaction points in the transaction point table 200.

Then, the processing unit 112 may execute the data access operation according to information in the transaction point 20b (that is, the transaction file allocation table and the file information table of the transaction point 20b).

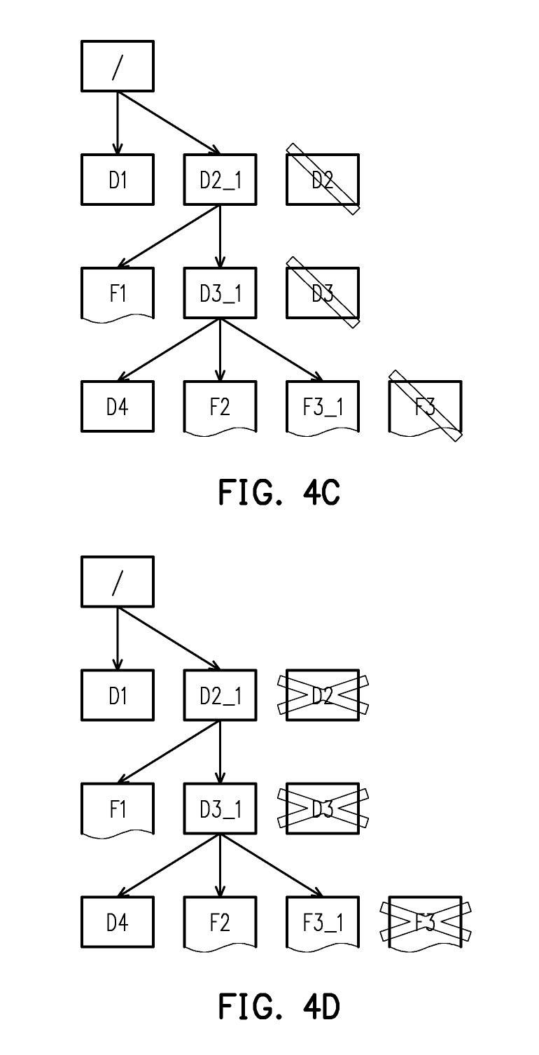

FIG. 4A-FIG. 4D are schematic diagrams of executing a data access operation shown according to an embodiment of the present invention.

Referring to FIG. 4A, assuming that the data access operation is to modify data F3 (also called as first data). The processing unit 112 may acquire a cluster (also called as a second cluster) correspondingly configured to store the data F3 and store file paths D2-D3 of the data F3 originally in the data cluster 210 in the transaction point 20a according to information copied to a transaction point 20b (namely a transaction file allocation table and a file information table of the transaction point 20b). Then referring to FIG. 4B, the processing unit 112 may copy the data F3 and the file paths D2-D3 to generate data F3_1 (also called as second data) and file paths D2_1-D3_1, and stores the data F3_1 and the file paths D2_1-D3_1 to an unused cluster (also called as a first cluster) in the data clusters 210 of the storage unit 114. Then, referring to FIG. 4C, the processing unit 112 may use a flag (also called as a first flag) to mark a cluster originally configured to store the data F3 and the file paths D2-D3 in the storage unit 114, so as to ensure that in the process of executing the data access operation, the original data F3 and file paths D2-D3 of the transaction point 20a may not be modified. Then, the processing unit 112 may execute the data access operation on the data F3_1 and the file paths D2_1-D3_1 generated by copying.

Particularly, in the process of executing the data access operation, because the cluster originally configured to store the data F3 and the file paths D2-D3 is marked by using the first flag and is reserved in the storage unit 114 without being modified, when failure (for example, the electronic apparatus 100 is powered off) occurs in the process of executing the data access operation, the processing unit 112 may restore the data F3 and the file paths D2-D3 in the previous transaction point (namely the transaction point 20a), so as to restore the storage unit 114 to a state in which the data access operation is not executed.

When the data access operation is completed, the electronic apparatus 100 may enter a commit state. At the moment, the processing unit 112 may execute a commit instruction, and set the transaction point 20b as the newest valid transaction point according to the commit instruction. Specifically, the processing unit 112 may generate check information according to the information recorded by the transaction file allocation table in the transaction point 20b and the count value in the transaction point 20b, and record the check information to the transaction file allocation table in the transaction point 20b. The check information may be generated by a familiar Exclusive OR (XOR) algorithm, and is not further described herein. In addition, referring to FIG. 4D, the processing unit 112 may also use another flag (also called as a second flag) to mark a second cluster configured to store the data F3 and the file paths D2-D3 to release a space of the second cluster. Then, the electronic apparatus 100 may enter a committed state, so that the processing unit 112 may execute other data access operations again.

It should be noted that in the present disclosure, a system for executing the operations of the embodiments of FIGS. 2, 3 and 4A-4D may be referred to as a transactional file system. In other words, the electronic apparatus 100 of FIG. 1 includes a transactional file system to perform the operations of FIGS. 2, 3 and 4A-4D mentioned above.

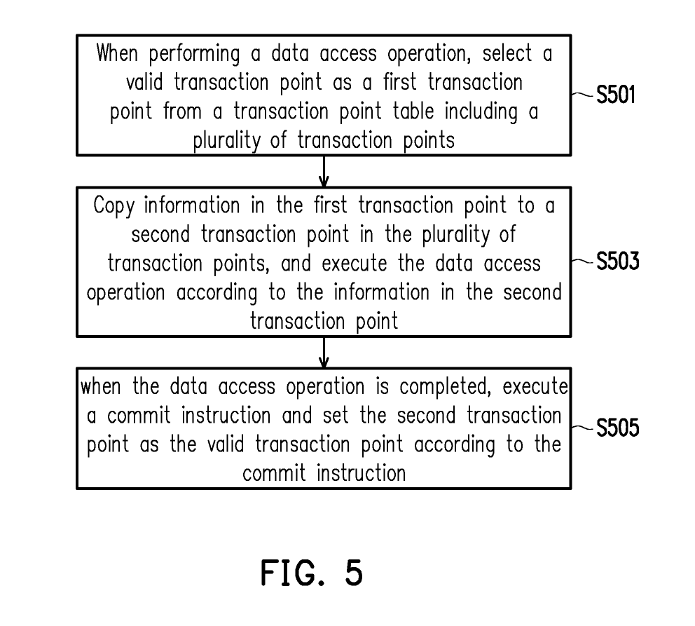

FIG. 5 is a flow diagram of a data access method of transactional file system shown according to an embodiment of the present invention.

Referring to FIG. 5, when data access operation is executed, in step S501, a processing unit 112 selects a valid transaction point as a first transaction point from a transaction point table including a plurality of transaction points. Then in step S503, the processing unit 112 may copy information in the first transaction point to a second transaction point in the plurality of transaction points, and executes the data access operation according to the information in the second transaction point. When the data access operation is completed, in step S505, the processing unit 112 executes a commit instruction, and sets the second transaction point as the valid transaction point according to the commit instruction.

Based on the above, the present invention provides the data access method of transactional file system and the electronic apparatus applying the method, and when a user accesses a file, a file system enters a state of Start Transaction. When all access actions in transaction have been successfully executed, commit may be started, and a new valid transaction point may be established. When establishment of the new valid transaction point is completed, the system may enter a committed state, and at the moment, next transaction may be performed. When unpredictable conditions such as power failure and crash occur at the system, the file system may return to a correct state of transaction or a correct state before the data access operation again. Therefore, the invention provides the capacity of Fail-safe of the file system of the FAT on a mobile device.

Although the present invention has been disclosed as above through the embodiments, the embodiments are not intended to limit the present invention, any person of ordinary skill in the art may make some alternation and modification without deviating from the spirit and scope of the present invention, and therefore, the protection scope of the present invention should be subject to the appended claims.

What is claimed is:

1. A data access method of transactional file system, which is applied to an electronic apparatus with a storage unit, the storage unit storing a transaction point table, the transaction point table including a plurality of transaction points, and the method comprising:
when performing a data access operation, selecting a valid transaction point as a first transaction point from the plurality of transaction points of the transaction point table;
copying information in the first transaction point to a second transaction point in the plurality of transaction points, and executing the data access operation according to the information in the second transaction point; and
when the data access operation is completed, executing a commit instruction, and setting the second transaction point as the valid transaction point according to the commit instruction.

2. The data access method of transactional file system according to claim 1,
further comprising:
when failure occurs in the process of executing the data access operation, restoring the storage unit to a state in which the data access operation is not executed by using the information in the first transaction point.

3. The data access method of transactional file system according to claim 1, wherein the step of executing the data access operation comprises:
copying first data corresponding to the first transaction point to generate second data, and storing the second data into a first cluster of the storage unit;
using a first flag to mark a second cluster configured to store the first data and a file path of the first data in the storage unit; and
executing the data access operation on the second data.

4. The data access method of transactional file system according to claim 3, wherein after the step of setting the second transaction point as the valid transaction point according to the commit instruction, the method further comprises:
using a second flag to mark the second cluster configured to store the first data and the file path of the first data so as to release a space of the second cluster.

5. The data access method of transactional file system according to claim 1, wherein the step of copying information in the first transaction point to the second transaction point in the plurality of transaction points comprises:
generating a count value and recording the count value into the second transaction point, wherein the count value in the second transaction point is greater than count values of other transaction points in the transaction point table.

6. The data access method of transactional file system according to claim 5, wherein the step of setting the second transaction point as the valid transaction point according to the commit instruction comprises:
generating check information according to the information in the second transaction point and the count value in the second transaction point, and recording the check information into the second transaction point.

7. The data access method of transactional file system according to claim 1, wherein the second transaction point in the transaction point table is a next transaction point of the first transaction point.

8. The data access method of transactional file system according to claim 1, each of the plurality of transaction points includes a transaction file allocation table and a file information table.

9. The data access method of transactional file system according to claim 1, wherein a count value of the valid transaction point is greater than count values of other transaction points in the transaction point table, and the valid transaction point includes correct check information.

10. An electronic apparatus, comprising:
a storage unit, storing a transaction point table, wherein the transaction point table includes a plurality of transaction points; and
a processing unit, wherein
when the processing unit executes a data access operation, the processing unit selects a valid transaction point as a first transaction point from the plurality of transaction points of the transaction point table,
the processing unit copies information in the first transaction point to a second transaction point in the plurality of transaction points, and executes the data access operation according to the information in the second transaction point, and
when the data access operation is completed, the processing unit executes a commit instruction, and sets the second transaction point as the valid transaction point according to the commit instruction.

11. The electronic apparatus according to claim 10, wherein
when failure occurs in the process of executing the data access operation, the processing unit restores the storage unit to a state in which the data access operation is not executed by using the information in the first transaction point.

12. The electronic apparatus according to claim 10, wherein in the process of executing the data access operation,
the processing unit copies first data corresponding to the first transaction point to generate second data, and stores the second data into a first cluster of the storage unit,
the processing unit uses a first flag to mark a second cluster configured to store the first data and a file path of the first data in the storage unit, and
the processing unit executes the data access operation on the second data.

13. The electronic apparatus according to claim 12, wherein after the operation of setting the second transaction point as the valid transaction point according to the commit instruction,
the processing unit uses a second flag to mark the second cluster configured to store the first data and the file path of the first data so as to release a space of the second cluster.

14. The electronic apparatus according to claim 10, wherein in the operation of copying the information in the first transaction point to the second transaction point in the plurality of transaction points,
the processing unit generates a count value and records the count value into the second transaction point, and the count value in the second transaction point is greater than count values of other transaction points in the transaction point table.

15. The electronic apparatus according to claim 14, wherein in the operation of setting the second transaction point as the valid transaction point according to the commit instruction,
the processing unit generates check information according to the information in the second transaction point and the count value in the second transaction point, and records the check information into the second transaction point.

16. The electronic apparatus according to claim 10, wherein the second transaction point in the transaction point table is a next transaction point of the first transaction point.

17. The electronic apparatus according to claim 10, wherein each of the plurality of transaction points includes a transaction file allocation table and a file information table.

18. The electronic apparatus according to claim 10, wherein a count value of the valid transaction point is greater than count values of other transaction points in the transaction point table, and the valid transaction point includes correct check information.
